(19) United States
(12) Patent Application Publication
(10) Pub. No.: US 2015/0314519 A1
(43) Pub. Date: Nov. 5, 2015

(54) PACKAGING MACHINE HAVING A TOOL CHANGING SYSTEM

(71) Applicant: GEA FOOD SOLUTIONS GERMANY GMBH, Biedenkopf-Wallau (DE)

(72) Inventor: Reiner Paul, Steffenberg (DE)

(21) Appl. No.: 14/647,229

(22) PCT Filed: Nov. 26, 2013
(86) PCT No.: PCT/EP2013/074715

§ 371 Date: May 26, 2015

(30) Foreign Application Priority Data
Nov. 27, 2012 (DE) 10 2012 111 497.8

(51) Int. Cl. B29C 51/26; B23P 19/04

(52) U.S. Cl. CPC B29C 51/261; B23P 19/04

(57) ABSTRACT

The invention relates to a packaging machine, comprising a forming station, which has a deep-drawing punch, by means of which a film web is deep-drawn, wherein the deep-drawing punch is provided directly or indirectly on a drive, which moves the deep-drawing punch back and forth between two positions. The invention further relates to a method for installing a deep-drawing punch of a packaging machine on a drive or removing said deep-drawing punch from said drive.

The present invention relates to a packaging machine having a forming station which has a thermoforming die by way of which a film web is thermoformed, wherein the thermoforming die is directly or indirectly provided on a drive which moves said thermoforming die to-and-fro between two positions. The present invention furthermore relates to a method for mounting or dismounting, respectively, a thermoforming die of a packaging machine on or from a drive, respectively.

Packaging machines and methods, respectively, of this type are well known from the prior art and are employed, for example, in order to pack, slice-shaped foodstuffs, for example slices of sausage, cheese and/or ham, or other products which can be weighed and/or counted. These packaging machines are referred no as so-called form-fill-seal packaging machines (FFS packaging machines). In these packaging machines a lower film web is conveyed in a cyclic manner along the packaging machine, and initially one pack cavity or a plurality thereof is/are formed in the lower film web by a die. Subsequently, this packaging machine is filled in a filling station with slices of packaged articles, in particular slices of foodstuffs, or other packaged articles and subsequently closed with a lid film, and then singularized. Nowadays such packaging machines have to be employable in a very flexible manner and thus rapidly retoolable, that is to say that the packaging shape and/or the format of simultaneously produced items of packaging has to be very rapidly modifiable.

It has thus been the object of the present invention to provide a packaging machine which is very rapidly retoolable.

The object is achieved by a packaging machine having a forming station which has a thermoforming die by way of which a film web is thermoformed, wherein the thermoforming die is directly or indirectly provided on a drive which moves said thermoforming die to-and-fro between two positions, and the connection between the thermoforming die and the drive is provided as a quick-action closure.

The disclosure made with reference to this subject matter of the present invention also applies in equal measure to the other subject matter or the present invention, and vice versa.

The present invention relates to a packaging machine, in particular a form-fill-seal packaging machine (FFS packaging machine). In these packaging machines a lower film web is conveyed in a cyclic manner along the packaging machine, and initially one pack cavity or a plurality thereof is/are formed in the lower film web. According to the invention, this forming of the pack cavity in the film web is caused by a die or is supported by a die. Subsequently, this packaging machine is filled in a filling station with slices of packaged articles, in particular slices of foodstuffs, or other packaged articles which can be weighed and/or counted. Preferably, a multiplicity of pack cavities are thermoformed, filled, and provided with a lid film in a substantially simultaneous manner in one cycle. In the event of a plurality of pack cavities being simultaneously formed in the film web, preferably one die per pack cavity is provided. These dies are in each case directly or indirectly connected to at least one drive. Preferably, however, each die is provided with a separate drive, or a group of two or more dies is in each case provided with one drive. Consequently, the packaging machine preferably has a plurality of drives. Particularly preferably, each drive is fastened on the upper tool of the forming station, which for a die changeover may be moved away from the film web to be formed, in particular pivoted away or rotated away.

Accordingly, one or a plurality of dies is/are directly or indirectly connected according to the invention to a drive, for example a pneumatic, hydraulic, or electric drive. This drive moves the dies from a parking position in which the die does not exert any pressure on the film web, in particular in a downward manner, into a forming position in which said die thermoforms the film web and, on account thereof, forms the pack cavities.

It is now provided according to the invention to provide the connection between the thermoforming die and the drive as a quick-action closure. On account thereof, the changeover of the die can be performed very rapidly, and the retooling times are significantly reduced. A person skilled in the art could not have expected that a quick-action closure between the drive and the die can be provided, in spite of the high forces and the multiplicity of load cycles.

A quick-action closure is a form-fitting and/or force-fitting interconnection which is releasable at any time, in particular in a tool-free manner. This includes, for example, clip, tension, clamping or latching closures, or a coupling. The quick-action closure may also be a hinge which is inserted and/or latches into a latch. The force of an average human is sufficient for the quick-action closure to be engaged or released. The quick-action closure may be engaged or released by human hand. Preferably, there is no need for changing one's grip here.

According to a further inventive or preferred subject matter of the present invention, the connection between the thermoforming die and the drive is thus performed in a tool-free manner.

The connection between the drive and the thermoforming die preferably has a securing means. This securing means secures the die in the closure. Preferably, this is a spring-loaded securing means which has to be moved counter to the spring force, in order for the form fit and/or the force fit between the drive and the die to be established or released. The securing means preferably is designed such that the force for establishing the connection is lower than the force which is required for releasing the connection. In any case, the force to be applied preferably does not exceed average human force.

Preferably, a plurality of connections (13) are provided per die or group of dies. Said connections may be complementary or redundant.

A further subject matter of the present invention is a method for mounting or dismounting, respectively, a thermoforming die of a packaging machine on or from a drive, respectively, in which the thermoforming die is moved in relation to the drive.

The disclosure made with reference to this subject matter of the present invention also applies in equal measure to the other subject matter of the present invention, and vice versa.

On account of the relative movement of the die or of a group of dies in relation to a drive, the connection between the drive and the die is released. A person skilled in the art understands that this movement has to be different from the movement between the parking position and the forming position. Preferably, the thermoforming die is moved in a linear manner in relation to the drive. Particularly preferably, the linear movement is oriented so as to be perpendicular to the operating movement between the parking position and the forming position.

Alternatively or additionally, the thermoforming die is rotated in relation to the drive.

Preferably, in the mounting or dismounting movement, respectively, of the thermoforming die the force of a securing means has to be overcome. Particularly preferably, said movement is performed in a fitful manner at the start or end thereof.

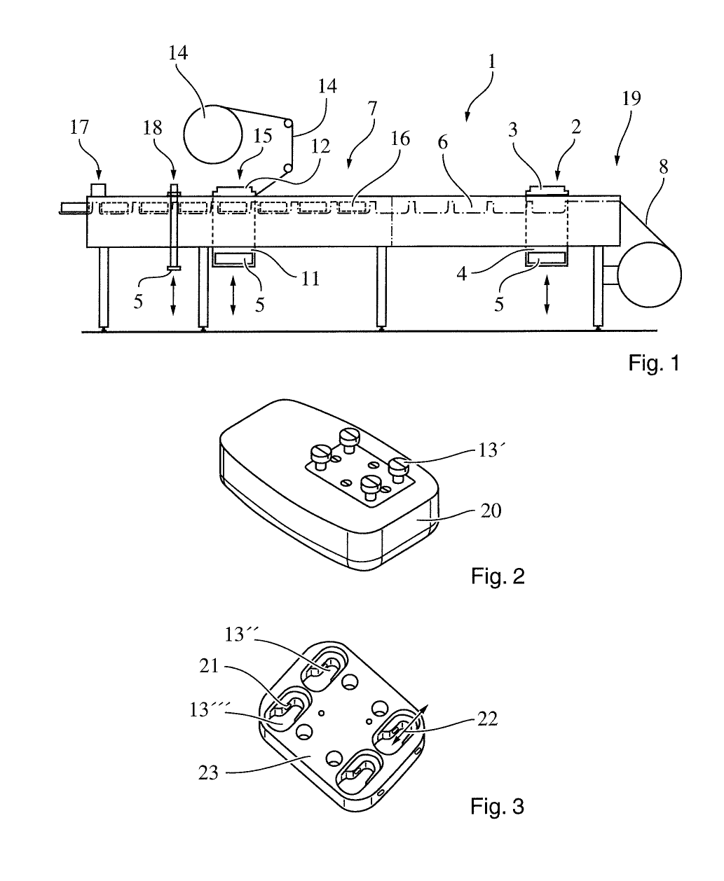

The inventions are explained in the following by means of FIGS. 1 to 3. These explanations are merely exemplary and do not limit the general concept of the invention. The explanations apply in equal measure to all subject matter of the present invention.

FIG. 1 shows the packaging machine according to the invention.

FIGS. 2 and 3 show the connecting means.

FIG. 1 shows the packaging machine 1 according to the invention, which has a thermoforming station 2, a filling station 7, and a sealing station 19. A lower film web 8, here a plastic film web S, is drawn off from a supply roll and is conveyed in a cyclic manner from right to left along the packaging machine according to the invention. In One cycle the lower film web 8 is conveyed onward by the length of one format. To this end, the packaging machine has two conveying means (not shown), in the present case in each case two endless chains which are disposed to the right and the left of the lower film web 8. At the beginning as well as at the end of the packaging machine at least one gear wheel about which the respective chain is deflected is provided for each chain. At least one of these gear wheels is driven. The gear wheels in the entry region and/or in the exit region may be interconnected, preferably by a rigid shaft. Each conveying means has a multiplicity of clamping means which grip the lower film web 8 in a clamping manner in the infeed region 24 and transmit the movement of the conveying means to the lower film web 8. The clamping connection between the conveying means and the lower film web 8 is released again in the delivery region of the packaging machine. The pack cavities 6 are formed in the film web 8 in the thermoforming station 2 which has an upper tool 3 and a lower tool 4 which has the shape of the pack, cavity to be produced. The lower tool 4 is disposed on a lifting table 5 which is vertically adjustable, as is symbolized by the double arrow. Prior to each indexing of the film the lower tool 4 is retracted and thereafter raised again. According to the invention, the forming of the lower web is at least supported by one die per pack cavity, which is provided on one upper tool 3 and may be lowered by a drive from a raised parking position into a forming position and is raised again prior to the film web 8 being conveyed onward. In the further coarse of the packaging machine the pack cavities are filled, in the filling station 7 with the slice-shaped packaged article 16. In the sealing station 15 which is subsequent thereto and which likewise is composed of an upper tool 12 and a vertically adjustable lower tool 11, an upper film 14 is fastened on the lower film web 8 in a form-fitting manner, preferably by way of sealing. The upper tool and/or the lower tool, are/is also lowered or raised, respectively, in the sealing station prior and subsequent to each film conveying operation. The upper film 14 may also be guided in conveying means or be conveyed by conveying chains, respectively, wherein these conveying means in this case only extend from the sealing station and, if applicable, in the downstream direction. Otherwise the comments made with reference to the conveying means of the lower film apply. In the further course of the packaging machine the completed items of packaging are singularized, which in the present case is performed by way of the transverse cutter 25 and the longitudinal cutter 17, The transverse cutter 25 in the present case likewise can be raised or lowered, respectively, by way of a lifting unit 9.

The die 20 by way of which the lower film web 8 is thermoformed is connected according to the invention by a quick-action closure 13 to the drive (not shown), here in an indirect manner via an adapter plate 23 (cf. FIGS. 2 and 3). The quick-action closure in the present case is composed of four mushrooms 13′ which, in order to connect co the drive, are in each case introduced into a clearance 13′″ which is provided in an adapter plate which is connected to the drive. The shape of the clearance 13′″ corresponds to the shape of the head of the mushroom. The head of the mushroom is completely guided through the clearance. Thereafter, the die is displaced upward in a linear manner toward the right, as is illustrated, by the double arrow 22. On account thereof, the head of the mushroom engages with the peripheral region of the slot 13″, and the die is secured on the adapter plate 23 by clamping. The base of the mushroom is located in the slot. Dismounting is performed in the reverse order. A person skilled in the art will see that more or fewer than four connections 13 may also be provided per die. In order to ensure that the die is not automatically released during operation, a securing means 21, here a spring-loaded protrusion, which reversibly minimizes the transition between the bore 13′″ and the slot is provided. This spring force has to be overcome during introduction or during dismounting, respectively. In the present case, the mushrooms are screwed into the die. On account thereof, the clamping force between the mushrooms 13′ and the slot 13″ can be adjusted or, in the case of wear, readjusted, respectively. However, the screws are not turned during the quick-action mounting.

### List of Reference Signs

1 Packaging machine

2 Forming station, thermoforming station

3 Upper tool of the thermoforming station

4 Lower tool of the thermoforming station

5 Lifting table, carrier of a tool of the sealing station, thermoforming station, and/or of the cutting unit

6 Pack cavity

7 First filling station

8 Film web, lower film web

9 Lifting unit

10 Drive

11 Lower tool of the sealing station

12 Upper tool of the sealing station

13 Connection between drive and die, quick-action closure

13′ Mushroom

13″ Slot

13′″ Clearance, bore

14 Upper film web, lid film

15 Sealing station

16 Packaged article

17 Longitudinal cutter

18 Transverse cutter

19 Infeed region

20 Thermoforming die

21 Securing means

22 Linear movement

23 Adapter plate

What is claimed is:

1. A packaging machine comprising:
a forming station which has a thermoforming die by way of which a film web is thermoformed,
wherein the thermoforming die is directly or indirectly provided on a drive which moves said thermoforming die to-and-fro between two positions,
wherein a form-fitting and/or force-fitting connection between the thermoforming die and the drive is provided as a quick-action closure,
wherein the form-fitting and/or force-fitting connection has a spring-loaded securing means for producing and releasing the form-fitting and/or force-fitting, connection, moves counter to a spring force,
wherein the spring force for establishing the connection is lower than a force which is required for releasing the connection, however, in any case the force to be applied does not exceed average human force.

2. The packaging machine as claimed in claim 1, wherein the form-fitting and/or force-fitting connection between the thermoforming die and the drive is performed in a tool-free manner.

3. (canceled)

4. The packaging machine as claimed in claim 1, wherein a plurality of connections are provided per die.

5. A method for mounting or dismounting, respectively, a thermoforming die of a packaging machine on or from a drive, respectively, wherein the thermoforming die is moved in relation to the drive,
wherein the mounting or dismounting movement, respectively, of the thermoforming die the force of a securing means has to be overcome, and
wherein the force for establishing the connection is lower than the force which is required for releasing the connection, however, in any case the force to be applied does not exceed average human force.

6. The method as claimed in claim 5, wherein the thermoforming die is moved in a linear manner in relation to the drive.

7. The method as claimed in claim 6, wherein the linear movement is oriented so as to be perpendicular to the operating movement.

8. The method as claimed in claims 5, wherein the thermoforming die is rotated in relation to the drive.

9. (canceled)

10. The method as claimed in claim 6, wherein the thermoforming die is rotated in relation to the drive.

11. The method as claimed in claim 7, wherein the thermoforming die is rotated in relation to the drive.
